(19) United States
(12) Patent Application Publication
(10) Pub. No.: US 2010/0213335 A1
(43) Pub. Date: Aug. 26, 2010

(54) SWIVELABLE FIXING SEAT

(76) Inventors: Chih-Ming Peng, Taoyuan City (TW); Tseng-Chun Huang, Taoyuan City (TW); Hsin-Hung Yeh, Taoyuan City (TW)

Correspondence Address: SINORICA, LLC, 2275 Research Blvd., Suite 500, ROCKVILLE, MD, 20850, US

(21) Appl. No.: 12/389,609

(22) Filed: Feb. 20, 2009

(51) Int. Cl. F16M 13/02

(52) U.S. Cl. 248/276.1

(57) ABSTRACT

The present invention discloses a swivelable fixing seat, which comprises the casing sleeves the seat body. The seat body has at least one elastic element and a guide slot. Compressing the elastic element makes the accommodation base and the two movable clamp members retract into or protrude from the casing, whereby the unused fixing seat occupies less space. The casing has a shaft thereinside. A screw fastens the shaft to the seat body, and another screw penetrates the guide slot and fastens to a screw stud of the seat body. Rotating the shaft drives the screw to slide in the guide slot to guide the rotation of the electronic device. Then, the electronic device is positioned at a specified angle.

### BACKGROUND OF THE INVENTION

1. Field of the Invention

The present invention relates to a swivelable fixing seat, particularly to a swivelable fixing seat, which can be adapted to different-size portable devices, swiveled to and positioned at the best angle, and retracted to the minimum volume.

2. Description of the Related Art

There are various portable electronic devices available in the market, including mobile phones, PDA (Personal Digital Assistant), multimedia play devices (such as MP3, MP4, and iPOD), and vehicular navigation devices. Most of them are equipped inside a vehicle, installed on a fixing frame, and used in a hand-free state.

Refer to FIG. 1 a diagram schematically showing a conventional in-vehicle fixing frame. The conventional fixing frame comprises a frame body 10, a supporter 11 and a fixing base 12. The frame body 10 has a baseplate 101 and a holder 102. The baseplate 101 and the holder 102 form an accommodation space for a portable electronic device. The holder 102 may be in form of two hooked clamp boards arranged in two sides of the baseplate 101 to clamp the portable electronic device. The supporter 11 may be a flexible aluminum rod with one end joined to the baseplate 101 and the other end joined to the fixing base 12. A sucking disc 121 is fixed to the back of the fixing base 12 and used to attach the fixing frame to the windshield or any place the user wants. Thereby, the portable electronic device can be used in a hand-free way and accessed conveniently without interfering with the vision of the driver.

However, the conventional in-vehicle fixing frame has the following disadvantages:

(1) The holder 102 cannot be adjusted to fit different-size portable electronic devices; thus the portable electronic device may drop from the fixing frame or even be damaged.

(2) The sucking disc 121 will age and lose elasticity after a long time use; thus the sucking disc 121 will be hard to adhere to an object.

(3) Because of the insufficient stiffness of the aluminum rod of the supporter 11, the angle of the supporter 11 or the position of the portable electronic device is likely to be varied by a careless touch or an urgent braking. Thus, the angle of the supporter 11 or the position of the portable electronic device has to be readjusted, which inconveniences the user. Moreover, the sucking disc 121 may lose the sucking ability because of an inappropriate movement of the supporter 11, and the fixing frame thus drops. Therefore, the conventional fixing frame is hard to achieve the device-fixing and angle-adjusting functions simultaneously.

(4) The conventional fixing frame is bulky and incollapsible, which not only causes the problems of collection and esthetics but also interferes with the vision of the driver.

Accordingly, the present invention proposes a swivelable fixing seat to effectively solve the abovementioned problems.

### SUMMARY OF THE INVENTION

The primary objective of the present invention is to provide a swivelable fixing seat, wherein compressing the elastic elements retracts the fixing seat to a minimum volume, whereby the fixing seat occupies less space.

Another objective of the present invention is to provide a swivelable fixing seat, wherein the user can fix or release the electronic device via rotating two movable clamp members, wherefore the present invention can prevent the electronic device from drop or damage caused by vibration or collision.

A further objective of the present invention is to provide a swivelable fixing seat, which has a rotation-positioning mechanism for the electronic device, wherefore the present invention can promote convenience of operating the electronic device.

To achieve the abovementioned objectives, the present invention proposes a swivelable fixing seat, which comprises a seat body, two movable clamp members, an accommodation base, and a casing. The seat body has a front seat plate joined to a fixing plate via at least one first elastic element. The fixing plate is installed on the casing and has a screw stud. The accommodation base is installed on the front seat plate and has a recess on the upper surface thereof to function as an accommodation socket receiving an electronic device. The front seat plate has two rotation members, which are respectively joined to the two movable clamp members via second elastic elements. The two rotation members implement the rotation, releasing and positioning operations of the two movable clamp members for fixing or releasing the electronic device.

The accommodation base further has a connection terminal and a second snap-fit element. The connection terminal emerges from a hole of the accommodation socket and is to plug in an electronic device for charging or signal transmission. The second snap-fit element is able to snap-fit to a first snap-fit element on the fixing plate.

The casing sleeves the seat body. The two movable clamp members and the accommodation base can protrude from or retract into the casing via compressing the first elastic elements. The casing has a shaft thereinside. A rear seat plate of the seat body has a guide slot. The shaft penetrates the front seat plate and the fixing plate to reach the rear seat plate, and a screw fastens the shaft to the rear seat plate. Another screw penetrates the guide slot and fastens to a screw stud of the seat body. Rotating the shaft drives the screw to slide in the guide slot to guide the rotation of the electronic device to a desired angle, and then the electronic device is positioned at the angle. Therefore, the present invention enables the user to adjust the application status of the fixing seat according to his requirement.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing a conventional in-vehicle fixing frame;

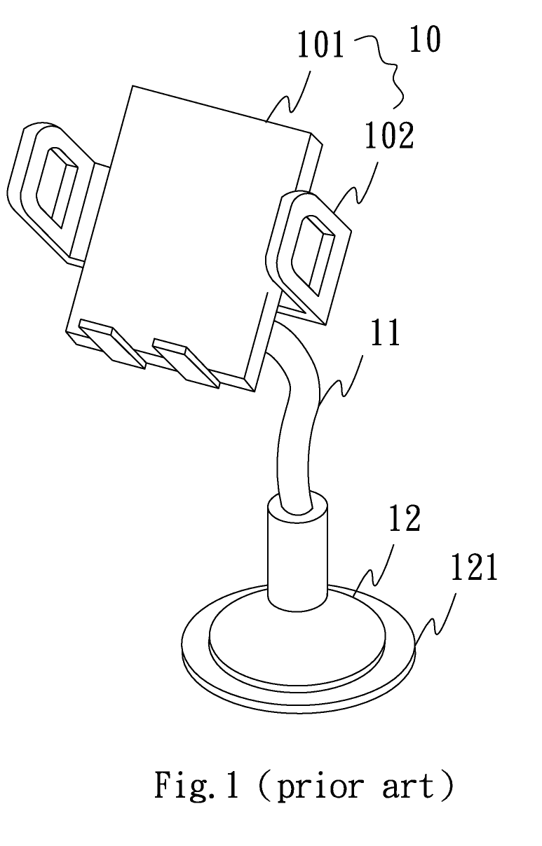

FIG. 2 is a perspective view schematically showing the assembly of a swivelable fixing seat according to one embodiment of the present invention;

FIG. 3 is a perspective exploded view schematically showing a swivelable fixing seat according to one embodiment of the present invention;

FIG. 4 is a sectional view schematically showing a swivelable fixing seat according to one embodiment of the present invention;

FIG. 5 is a diagram schematically showing the operation of two movable clamp members according to one embodiment of the present invention;

FIG. 6 is a perspective view schematically showing a retracted swivelable fixing seat according to one embodiment of the present invention;

FIG. 7 is a sectional view of the retracted swivelable fixing seat shown in FIG. 6;

FIG. 8 is a front view schematically showing the swiveling and positioning operations of a swivelable fixing seat according to one embodiment of the present invention; and

FIG. 9 is a rear view schematically showing the swiveling and positioning operations of a swivelable fixing seat according to one embodiment of the present invention.

### DETAILED DESCRIPTION OF THE INVENTION

The embodiments of the present invention are described in detail in cooperation with the attached drawings, wherein the identical element is denoted with an identical numeral.

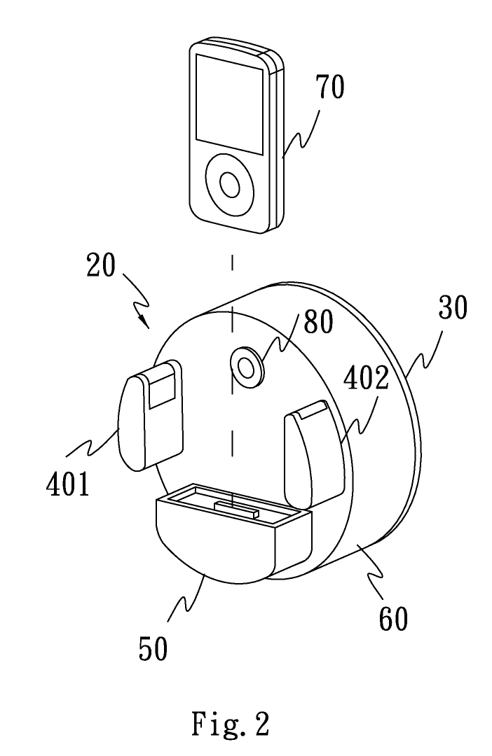

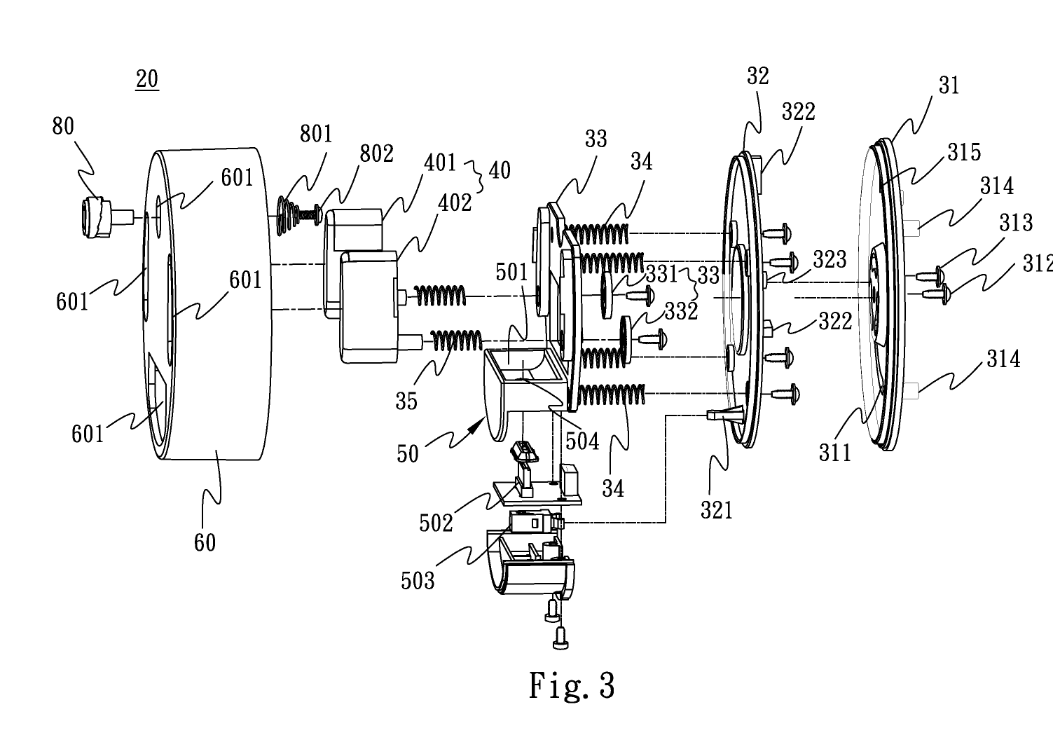

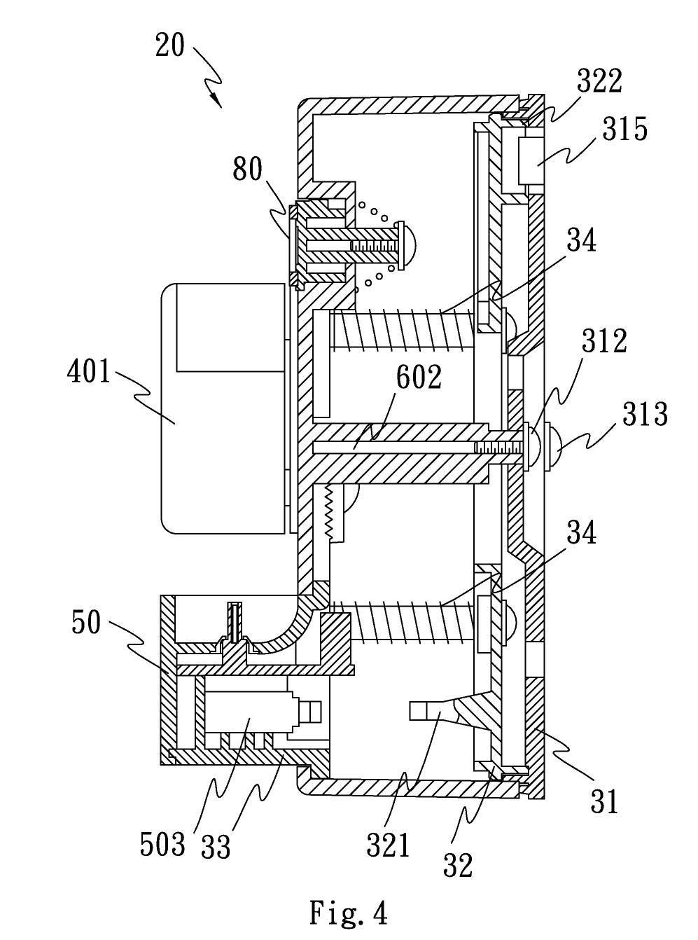

Refer to FIG. 2, FIG. 3 and FIG. 4. FIG. 2 is a perspective view schematically showing the assembly of a swivelable fixing seat according to one embodiment of the present invention. FIG. 3 is a perspective exploded view schematically showing a swivelable fixing seat according to one embodiment of the present invention. FIG. 4 is a sectional view schematically showing a swivelable fixing seat according to one embodiment of the present invention. In FIG. 3, the swivelable fixing seat 20 of the present invention comprises a seat body 30, two movable clamp members 40, an accommodation base 50, and a casing 60. The seat body 30 includes a rear seat plate 31, a fixing plate 32 and a front seat plate 33.

The front seat plate 33 is connected to the fixing plate 32 via a plurality of first elastic elements 34, which may be springs, and the fixing plate 32 is installed in the casing 60. The accommodation base 50 is installed on the front seat plate 33 and has a recess on the upper surface thereof to function as an accommodation socket 501. The accommodation base 50 further has a connection terminal 502 and a second snap-fit element 503. The connection terminal 502 emerges from a hole 504 of the accommodation socket 501. The fixing plate 32 has a first snap-fit element 321, and the first snap-fit element 321 can snap-fit to the second snap-fit element 503.

The front seat plate 33 has two rotation members, which may be in form of a first rotation member 331 and a second rotation member 332, and which may be realized with ratchet wheels. The two movable clamp members 40 may be in form of a first movable clamp member 401 and a second movable clamp member 402. The first rotation member 331 is connected to the first movable clamp member 401 with a second elastic element 35, and the second rotation member 332 is connected to the second movable clamp member 402 with a second elastic element 35. The second elastic elements 35 may be realized with springs.

The casing 60 sleeves the seat body 30 and has openings 601 respectively corresponding to the first movable clamp member 401, the second movable clamp member 402 and the accommodation base 50, whereby the first movable clamp member 401, the second movable clamp member 402 and the accommodation base 50 can protrude from or retract into the casing 60. The casing 60 further has a positioning element 80 and an opening 601 corresponding to the positioning element 80. A third elastic element 801 sleeves the positioning element 80, and a screw 802 fastens the positioning element 80 to the casing 60. The third elastic element 801 may be realized with a spring. The casing 60 has a shaft 602 thereinside. The shaft 602 penetrates the front seat plate 33 and the fixing plate 32 to reach the rear seat plate 31, and a screw 312 fastens the shaft 602 to the rear seat plate 31. The rear seat plate 31 has a guide slot 311, and a screw 313 penetrates the guide slot 311 and fastens to a screw stud 323 of the fixing plate 32, whereby the rotating shaft 602 can drive the screw 313 to slide in the guide slot 311 to guide the rotation movements. Then the clamped object is positioned at a specified angle.

In FIG. 2, an electronic device 70 is to be placed in the accommodation socket 501—a recess on the upper surface of the accommodation base 50, and the connection terminal 502 of the accommodation base 50 will be plugged into the connection terminal of the electronic device 70 for charging or signal transmission. The user can manually adjust the positioning element 80 and the third elastic element 801 to regulate the depth of the accommodation space to meet thicknesses of different electronic devices, whereby the utility of the swivelable fixing seat 20 of the present invention is increased.

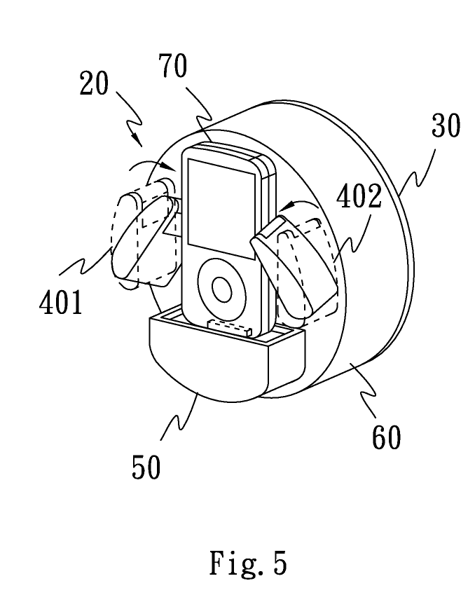

Refer to FIG. 2, FIG. 3 and FIG. 5. FIG. 5 is a diagram schematically showing the operation of two movable clamp members according to one embodiment of the present invention. After placed in the accommodation base 50, the electronic device 70 is interposed between the first movable clamp member 401 and the second movable clamp member 402. The first movable clamp member 401 and the second movable clamp member 402 are respectively connected to the first rotation member 331 and the second rotation member 332 with the second elastic elements 35. With the elasticity and resilience of the second elastic elements 35, the user respectively rotates the first movable clamp member 401 and the second movable clamp member 402 to a special angle and positions them at the angle to regulate the spacing thereof to clamp the electronic device 70 securely lest the electronic device 70 drop because of vibration or collision.

When the user intends to release the electronic device 70 from the clamping of the first and second movable clamp members 401 and 402, he presses the first and second movable clamp members 401 and 402. Thus, the first and second rotation members 331 and 332 use the resilience of the second elastic elements 35 to restore the first and second movable clamp members 401 and 402 to the original positions. Then, the electronic device 70 can be easily taken out from the swivelable fixing seat 20.

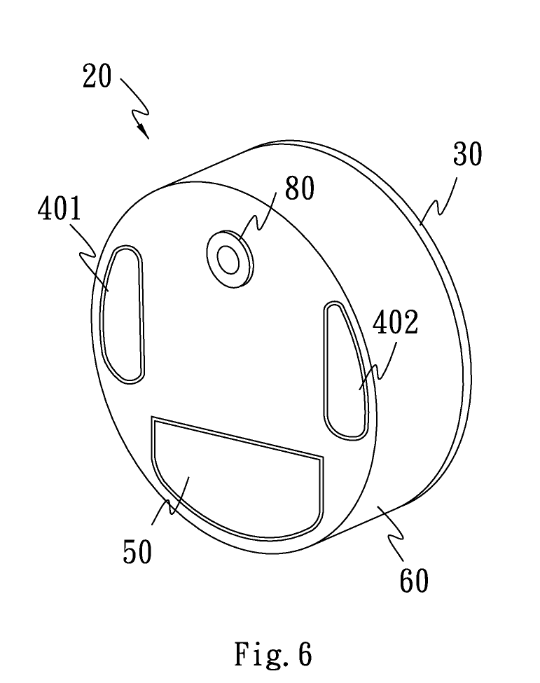

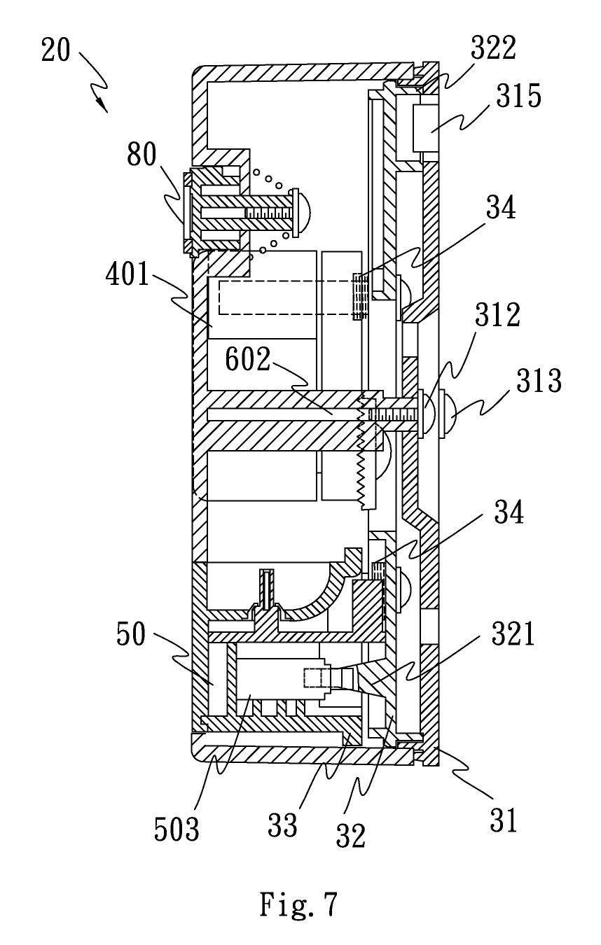

Refer to FIG. 3 and FIG. 4, FIG. 6 and FIG. 7. FIG. 6 is a perspective view schematically showing a retracted swivelable fixing seat according to one embodiment of the present invention. FIG. 7 is a sectional view of the retracted swivelable fixing seat shown in FIG. 6. When the user intends to reduce the volume of the swivelable fixing seat 20 to the minimum, he presses any one of the first movable clamp member 401, the second movable clamp member 402 and the accommodation base 50 to achieve that. The first movable clamp member 401, the second movable clamp member 402 and the accommodation base 50 are installed on the front seat plate 33, and the front seat plate 33 are connected to the fixing plate 32 via several first elastic elements 34 (such as springs). When the first elastic elements 34 are compressed, the second snap-fit element 503 of the front seat plate 33 is pushed to snap-fit to the first snap-fit element 321 of the fixing plate 32. Thereby, the accommodation base 50, the first movable clamp member 401 and the second movable clamp member 402 are retracted into the casing 60, and the volume of the swivelable fixing seat 20 is decreased. Thus, the swivelable fixing seat 20 is easy to collect and occupies less space.

When the user intends to use the swivelable fixing seat 20, he also presses any one of the first movable clamp member 401, the second movable clamp member 402 and the accommodation base 50. When the first elastic elements 34 are compressed again, the second snap-fit element 503 is detached from the first snap-fit element 321. Then, the resilience of the first elastic elements 34 pushes out from the casing 60 the accommodation base 50, the first movable clamp member 401 and the second movable clamp member 402, as shown in FIG. 4. Then, the user can place an electronic device in the swivelable fixing seat 20.

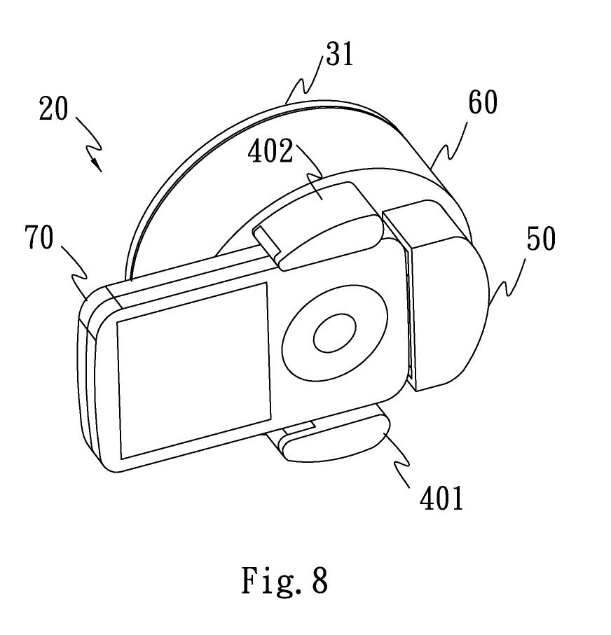

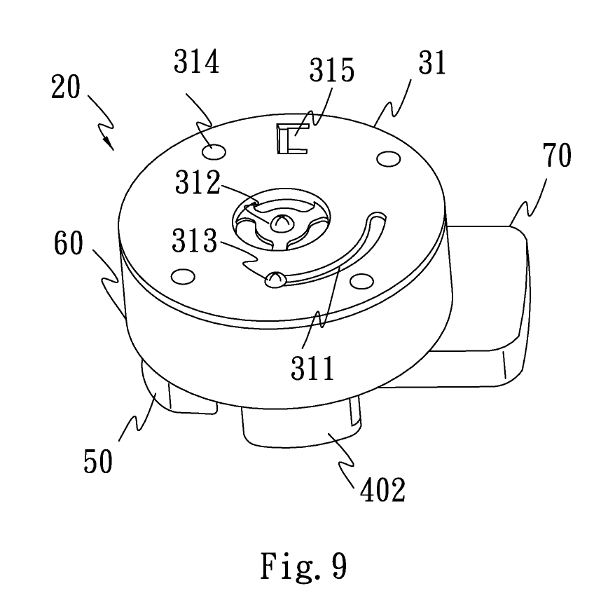

Refer to FIG. 3, FIG. 7, FIG. 8 and FIG. 9. FIG. 8 is a front view schematically showing the swiveling and positioning operations of a swivelable fixing seat according to one embodiment of the present invention. FIG. 9 is a rear view schematically showing the swiveling and positioning operations of a swivelable fixing seat according to one embodiment of the present invention. The shaft 602 of the casing 60 penetrates the front seat plate 33 and the fixing plate 32 to reach the rear seat plate 31, and the screw 312 fastens the shaft 602 to the rear seat plate 31. The screw 313 penetrates the guide slot 311 and fastens to the screw stud 323 of the fixing plate 32. The rear seat plate 31 has a snap-fit hook 315 corresponding to a snap-fit socket 322 of the fixing plate 32. When the user turns the casing 60 rightward by 90 degrees, the rotating shaft 602 drives the screw 313 to slide in the guide slot 311, and then the snap-fit hook 315 snap-fits to the snap-fit socket 322 to fix a relative position for horizontally placing the electronic device 70. When the user turns the casing 60 leftward by 90 degrees, a similar rotation-positioning mechanism implements the vertical placement of the electronic device 70. The rotation-positioning mechanism of the present invention can adjust the placement angle of the electronic device 70 and considerably conveniences the operation of the electronic device 70. As shown in FIG. 9, the backside of the rear seat plate 31 of the seat body 30 has several fixing elements 314, such as screw studs, whereby the user can install the swivelable fixing seat 20 to a vehicle body or any place he wants.

In conclusion, the present invention proposes a utility swivelable fixing seat to enable the user to adjust the application status thereof. Therefore, the present invention can effectively solve the problems of the conventional technology.

The embodiments described above are only to exemplify the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. A swivelable fixing seat comprising
a seat body;
two movable clamp members connected to said seat body, rotated and then positioned to securely clamp an electronic device;
an accommodation base installed on said seat body and having a recess on an upper surface thereof to function as an accommodation socket; and
a casing sleeving said seat body with said two movable clamp members and said accommodation base provide protrude from or retract into said casing.

2. The swivelable fixing seat according to claim 1, wherein said casing has a positioning element to adjust a space for accommodating said electronic device.

3. The swivelable fixing seat according to claim 1, wherein said seat body further comprises
a rear seat plate having a guide slot;
a fixing plate having a first snap-fit element and a screw stud; and
a front seat plate connected to said fixing plate via at least one first elastic element and having two rotation members respectively connected to said two movable clamp members via second elastic elements to implement rotation and positioning of said two movable clamp members, wherein said accommodation base and said two movable clamp members are installed on said front seat plate.

4. The swivelable fixing seat according to claim 3, wherein pressing said at least one first elastic element enables said accommodation base and said two movable clamp members to protrude from or retract into said casing.

5. The swivelable fixing seat according to claim 3, wherein said casing has a shaft thereinside; said shaft penetrates said front seat plate and said fixing plate to reach said rear seat plate; and a first screw fastens said shaft to said rear seat plate; a second screw penetrates said guide slot and fastens to said screw stud; and said shaft rotates to drive said second screw to slide in said guide slot to implement rotation and position of said swivelable fixing seat.

6. The swivelable fixing seat according to claim 3, wherein said at least one first elastic element and said second elastic elements are springs.

7. The swivelable fixing seat according to claim 3, wherein said two rotation members use elastic force and resilience of said second elastic elements to implement rotation and positioning of said two movable clamp members to realize rotation-to-clamp activities and rotation-to-release activities of said two movable clamp members.

8. The swivelable fixing seat according to claim 3, wherein said accommodation base further comprises a connection terminal and a second snap-fit element; said connection terminal emerges from a hole of said accommodation socket to plug in an electronic device for charging or signal transmission; said second snap-fit element provide snap-fit for said first snap-fit element.

9. The swivelable fixing seat according to claim 8, wherein said at least one first elastic element compressd drives said second snap-fit element to snap-fit into said first snap-fit element and makes said accommodation base and said two movable clamp members retract into said casing.

10. The swivelable fixing seat according to claim 8, wherein said at least one first elastic element compresses drives detach said second snap-fit element from said first snap-fit element, and then resilience of said at least one first elastic element makes said accommodation base and said two movable clamp members protrude from said casing.
